(19) United States
(12) Patent Application Publication
(10) Pub. No.: US 2013/0032379 A1
(43) Pub. Date: Feb. 7, 2013

(54) INTEGRATED CLAMP INSULATORS

(71) Applicants: Alf Baker, Dandenong South (AU); Gordon Chessum, Dandenong South (AU); Andrew Sorensen, Dandenong South (AU)

(72) Inventors: Alf Baker, Dandenong South (AU); Gordon Chessum, Dandenong South (AU); Andrew Sorensen, Dandenong South (AU)

(21) Appl. No.: 13/503,615

(22) PCT Filed: Oct. 14, 2010
(86) PCT No.: PCT/AU10/01352

§ 371 Date: Aug. 3, 2012

(30) Foreign Application Priority Data
Oct. 23, 2009 (AU) 2009905184

(51) Int. Cl. H01B 17/16

(52) U.S. Cl. 174/163 R

(57) ABSTRACT

An electrical insulator (12) comprising an insulator body (14) and a clamp (16) formed as an integral piece, wherein the insulator body has a base fitting for attachment to a support structure at one end with the clamp (16) being formed at the other end, said clamp having a body including a saddle (18) defining a hollow (20) for receiving an electrical conductor whether the electrical insulator is extending either substantially horizontally or substantially vertically from the support structure, and a bolt (30) upon which a keeper or retainer (26) is movable along a track (28) defined in the body of the clamp for securing an electrical conductor in the hollow (20).

### FIELD OF THE INVENTION

This invention relates to clamps for receiving conductors, specifically clamps integrated into insulators for receiving and holding securely electrical conductors.

### BACKGROUND OF THE INVENTION

The attachment of an electric power conductor, such as a cable, to support structures such as a pole or a pylon requires the use of an insulator and conductor secure means. Usually the conductor secure means is a form of clamp. Mechanical clamps used in conjunction with insulators have been in use for 30 or 40 years and while they have proven to be an improvement over top tie insulators, they suffer from a number of problems, arising from their construction and multiplicity of components.

“One piece” electrical power line insulators have been described in U.S. Pat. No. 5,837,943. These have a universal end clamp suitable for substantially horizontal or vertical applications, with a preferred embodiment being a line post insulator having a universal end clamp which has an electrical insulator with a base fitting for attachment to a support structure at one end and a universal clamp attached at the other end. The clamp has a body defining a saddle for receiving a conductor when the insulator is extending either substantially horizontally or substantially vertically from the support structure. The clamp also has a captive bolt on which a keeper is movable along a track defined in the body for securing a conductor in the saddle. The captive bolt is provided with a lock washer and nut to lock the keeper in place. The clamp is crimped on to the end of an insulator. However, this poses a problem in that the clamp and the insulator are formed separately and require mating before crimping can occur. Furthermore, in use and under load, the possibility of the crimping becoming less effective and the clamp separating from the insulator is real. Typically the components of the clamp, including captive bolt, lock washer, nut and keeper are composed of metal and hence are electrically conducting. This can pose safety problems when live or potentially live conductors are to be clamped. This safety-affecting factor is also present in other mechanical clamps.

The present invention aims at ameliorating these disadvantageous.

### SUMMARY OF THE INVENTION

According to one aspect of the invention there is provided an integrated insulator and clamp comprising an insulator body incorporating an integrated clamp saddle and conductor retaining means.

### DESCRIPTION OF THE INVENTION

According to one aspect of the invention there is provided an electrical insulator incorporating a universal end clamp, said insulator comprising an insulator body and a clamp being formed as an integral piece, wherein the insulator body has a base fitting for attachment to a support structure at one end with the clamp being formed at the other end. The clamp has a body defining a saddle or recess for receiving an electrical conductor whether the insulator is extending either horizontally or substantially vertically from the support structure, and a bolt upon which a keeper or retainer is movable along a track defined in the body of the clamp for securing an electrical conductor in the saddle or recess.

As will be appreciated, the insulator body and clamp are formed from the same non-conducting material. Preferably the insulator body and clamp are of a cast-as-one construction. An epoxy resin based moulded product containing hydrophobically treated filler is preferred. Moulding offers an advantage in that the moulded product is uniform in composition throughout, leading to consistency in strength and electrical resistance. The latter has a benefit in reduction of the probability of electrical discharge across the insulator. Alternatively, a reinforced plastics material may be used.

Preferably, the keeper or retainer is formed from the same material as the insulator. However, it is possible to use a keeper or retainer which is formed from metal, for example, die cast aluminum. More preferably the insulator and keeper are both formed by moulding. Preferably the bolt is a captive bolt. Preferably the keeper or retainer is biased against movement toward the saddle or recess by biasing means such as a spring interposed on the bolt between the keeper or retainer and the saddle or recess.

Washers may be interposed between the head of the bolt and the clamp body and the nut and the body of the keeper to spread the load and reduce pressure on the bodies of the clamp and keeper as the clamp and keeper are brought together to clamp an electrical conductor.

The other components of the inventive insulator, including the bolts, nuts, washers and biasing means, may be manufactured from metallic materials or non-conductive non-metallic materials.

The insulator body may be attached to electrical poles, pylons, cross arms, and structures in sub-stations. The insulator according to the invention may form part of an integrated cross arm insulator.

In use an insulator according to the invention is secured to a structure such as an electrical pole or pylon or a cross-arm or outrigger fixed to the foregoing. An electrical conductor, such as a power cable, is seated in the hollow or recess defined in the clamp body and the keeper or retainer is then moved along a track defined in the body of the clamp until it is brought into contact with the electrical conductor, and with further movement in the same direction, into a clamping relationship with the electrical conductor, in conjunction with the body of the clamp.

The integrated insulator body and clamp system of the invention provides an advantage over prior devices as it reduces the number of connections between parts (namely, removing the need for a connection between the clamp and the insulator body), thereby reducing the probability of failure at a point of connection as a result of stresses in use.

The reduction in the number of components in the integrated insulator body and clamp produces labour savings in assembly of the insulator and clamping of a conductor on site. There is no need to attach clamp top heads that normally have to be crimped or bolted to insulator ends either at the manufacturing site or in the field.

The orientation of the clamp in relation to the insulator body is fixed. However, different orientations can be achieved by using different moulds in the moulding of the insulator.

When the clamp and keeper are formed from the same non-conducting material as the insulator (which is preferred), the possibility of metal to metal gaps is significantly reduced, if not eliminated. This lessens the prospect of electrical potential differences being created across such gaps by an energized electrical conductor resulting in discharges which produce radio and television signal interference. The use of non-conductive materials in the clamp and keeper results in improved electrical insulating performance due to an increased electrical arc distance and increased creepage distance and thus pollution resistance when compared to a comparable insulator body of the same length and configuration fitted with a metal end cable clamp.

### DESCRIPTION OF PREFERRED EMBODIMENT

In order that the invention may be more clearly understood a preferred embodiment of the invention is described in relation to the following drawings in which:

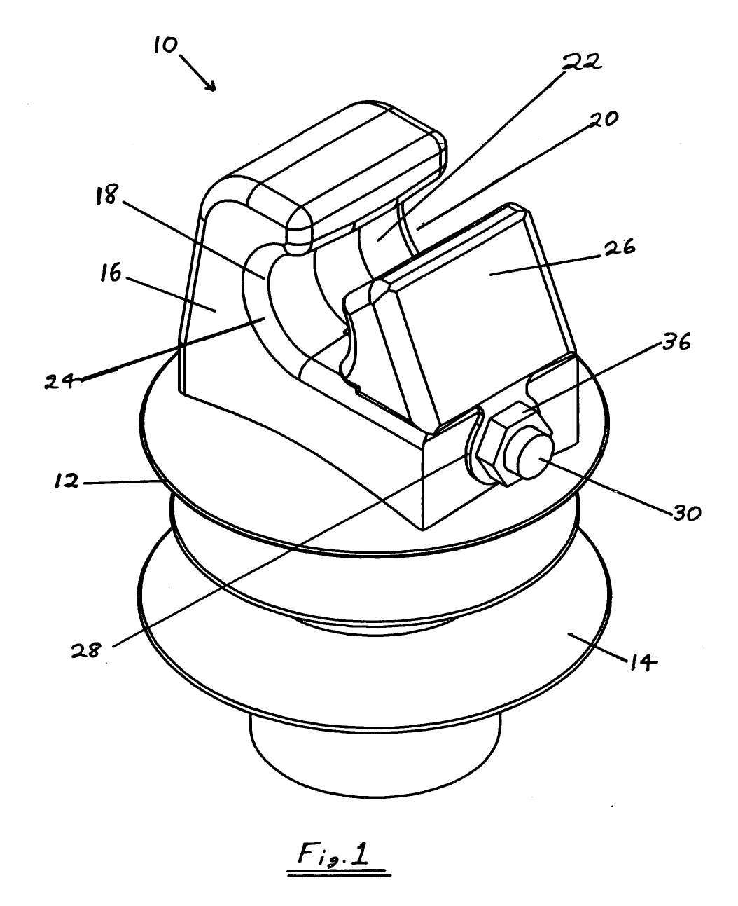

FIG. 1 is a perspective view of an embodiment of the invention;

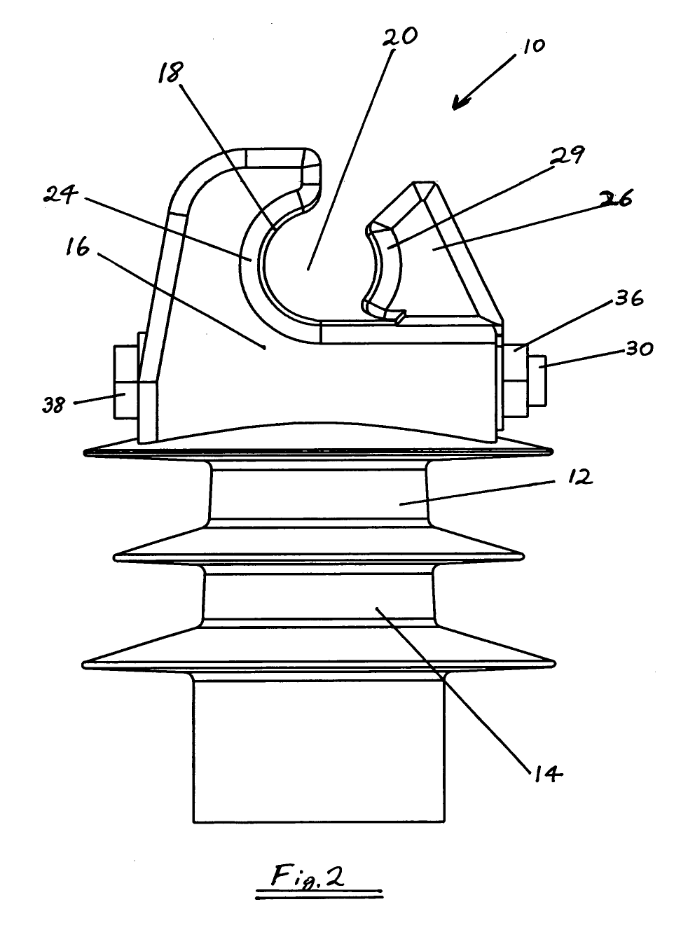

FIG. 2 is an elevational view of the embodiment of FIG. 1;

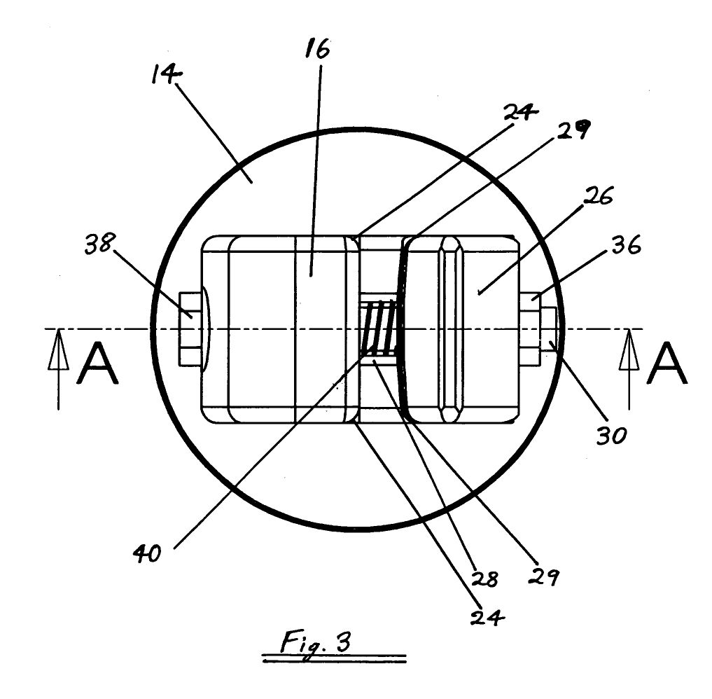

FIG. 3 is a plan view from above of the embodiment of FIG. 1; and

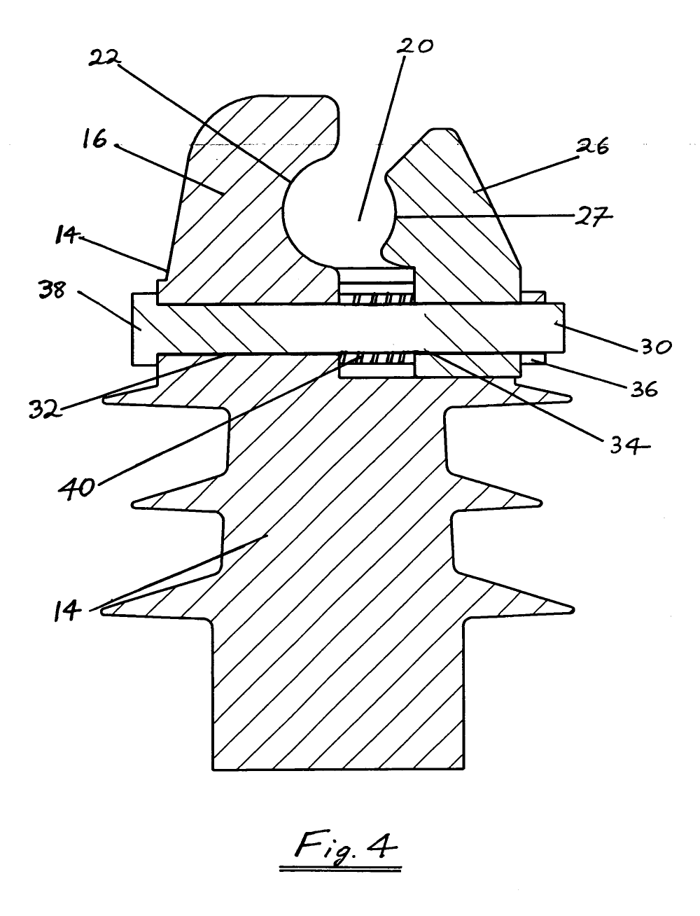

FIG. 4 is a sectional view along the lines A-A of FIG. 3.

In the drawings the numeral 10 designates generally a preferred embodiment of the invention which is an electrical insulator 12 comprising an insulator body 14 provided at one end with means (not shown) for securement to a support structure such as an electricity power pole and provided at the other end with a clamp 16. Clamp 16 includes a saddle 18 for receiving a conductor, said clamp 16 being integrally formed with the body of the insulator, preferably by moulding. More preferably, insulator body 14 and clamp 16 are “cast-as-one”. Preferably, insulator 12 is formed from an epoxy resin polymer provided with hydrophobic characteristics. The saddle 18 defines a hollow 20 for receiving an electrical conductor. The axis of said hollow 20 is transverse to the longitudinal axis of the insulator body 14. The hollow 20 is sized to accommodate a variety of electrical conductor sizes and preferably has a smooth conductor clamping zone 22 and outwardly flared ends 24 to provide for secure clamping of the electrical conductor with minimal abrasion. Also provided is a keeper 26 which is movable along a pathway 28 provided in the lower part of the clamp 16. The inner face 27 of the keeper 26 is profiled to provide a smooth conductor engaging zone which is also provided with outwardly flared ends 29 to achieve minimal abrasion of a clamped conductor. A bolt 30 passes through bores 32 and 34 provided in the clamp 16 and keeper 26, respectively, with the head 38 of the bolt 30 abutting an outer face of clamp 14. A nut 36 is provided at the other end of bolt 30 its inner face abutting an outer face of the keeper 26.

The nut 36 may be restrained from release from bolt 30 by means such as a pin (not shown) passing through the shaft of bolt 30 between the nut 36 and the free end of the bolt. The head 38 of the bolt 30 is fixed to the outer face of the clamp it abuts, or is otherwise restrained from rotation, so that the bolt 30 cannot rotate about its longitudinal axis. The nut 36 is rotated on the thread of the bolt 30 so that it moves along the bolt away from the free end of the bolt while engaging the outer face of the keeper 26 thereby moving the keeper 26 toward the hollow 20 of the clamp 16. The range of movement of the keeper 26 allowed by the structure of the clamp is intended to permit the acceptance, seating and clamping of a range of electrical conductor diameters.

An alternative is to provide the keeper 26 with a female thread. Rotation of the bolt leads to either the keeper advancing towards the clamp or retreating from the clamp as desired. The nut 36 may then be used as a locking nut to prevent the keeper 26 from working loose.

In use the embodiment is secured to an electrical power pole or staunchion, or cross arm or outrigger fixed to the same. An electrical conductor is seated in the hollow or recess, and is secured in place by rotating the nut on the shaft of bolt to draw the keeper 26 towards the hollow 20 and thereby engage the electrical conductor firmly and securely.

Washers (not shown here) may be interposed between the head 38 of the bolt 30 and the outer face of clamp 16 and between the nut 36 and the outer face of keeper 26 to spread the load when clamping of an electrical conductor takes place.

The keeper 26 is biased against closing on the hollow 20 by a spring 40 interposed on the shaft of the bolt between the body of the saddle and the keeper 26. Other methods of biasing the keeper 26 from closing on the hollow 20 may be used.

It is to be understood that the invention may embrace many further modifications as would be readily apparent to persons skilled in the art and which would be deemed to reside within the broad scope and ambit of the invention. The preferred embodiment described above is by way of example only and is not to be considered as limiting.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form or suggestion that the prior art forms part of the common general knowledge in Australia or elsewhere.

1. An electrical insulator comprising an insulator body and a clamp moulded or cast as formed as an integral unit, wherein the insulator body has a base fitting for attachment to a support structure at one end with the clamp being formed at the other end, said clamp having a body defining a saddle or recess for receiving an electrical conductor whether the electrical insulator is extending either substantially horizontally or substantially vertically from the support structure, and a bolt upon which a keeper or retainer is movable along a track defined in the body of the clamp for securing an electrical conductor in the saddle or recess, wherein said keeper or retainer and said insulator body and said clamp are formed from the same material.

2. An electrical insulator as claimed in claim 1 wherein said bolt is a captive bolt.

3. An electrical insulator as claimed in claim 1 wherein the keeper or retainer is biased against movement towards the saddle or recess by biasing means.

4. An electrical insulator as claimed in claim [[4]] 3 wherein said biasing means is formed from an electrically insulating material.

5. An electrical insulator as claimed in either claim 3 or claim 4 wherein said biasing means is a spring interposed on said bolt between said keeper or retainer and said saddle or recess.

6. An electrical insulator as claimed in claim 1 wherein said bolt is formed from an electrically insulating material.
